(19) United States
(12) Patent Application Publication
(10) Pub. No.: US 2013/0096795 A1
(43) Pub. Date: Apr. 18, 2013

(54) ELECTRONICALLY CONTROLLABLE BRAKE BOOSTER

(71) Applicant: MANDO CORPORATION, Gyeonggi-do (KR)

(72) Inventor: Gung Hun SIM, Gyeonggi-Do (KR)

(73) Assignee: MANDO CORPORATION, Gyeonggi-do (KR)

(21) Appl. No.: 13/648,879

(22) Filed: Oct. 10, 2012

(30) Foreign Application Priority Data
Oct. 10, 2011 (KR) 10-2011-0102797

(51) Int. Cl. B60T 7/04

(52) U.S. Cl. CPC B60T 7/042
USPC 701/70

(57) ABSTRACT

Disclosed herein is an electronically controlled brake booster. The electronically controlled brake booster includes a brake pedal sensor to detect a stroke of a brake pedal, a motor to transmit power required to generate a braking pressure, a cylinder pressure sensor to detect an internal pressure of a cylinder generated via the motor, and an electronic control unit to control driving of the motor. The electronic control unit includes a target pressure setting element to set a target pressure using the detected brake pedal stroke information and a proportional-integral controller to perform proportional-integral compensation of an error between the target pressure and the pressure of the cylinder. The electronic control unit further includes a proportional-integral gain adjustor to adjust at least one of a proportional gain and an integral gain of the proportional-integral controller using the cylinder pressure information detected via the cylinder pressure sensor.

### CROSS-REFERENCE TO RELATED APPLICATION

This application claims the benefit of Korean Patent Application No. 2011-0102797, filed on Oct. 10, 2011 in the Korean Intellectual Property Office, the disclosure of which is incorporated herein by reference.

### BACKGROUND

1. Field

Embodiments of the present invention relate to an electronically controlled brake booster.

2. Description of the Related Art

In general, an electric vehicle is a vehicle that is powered by electricity rather than fossil fuel, such as gasoline, etc. The electric vehicle does not discharge exhaust gas, and is environmentally friendly and generates less noise. Although the first electric vehicle was produced in 1873, it was not practical to use due to the weight of a battery mounted in the vehicle, a battery charge time, and so on.

However, as environmental pollution has gradually worsened, development of electric vehicles has resumed. The core of the electric vehicle is a battery, and lower battery weight and size and shorter battery charge time are the most important considerations for commercialization of the electric vehicle.

A hybrid electric vehicle is a vehicle that is powered by both a conventional engine and an electric motor (drive motor). The hybrid electric vehicle achieves high fuel-efficiency and low pollution by selectively using power of the engine or the electric motor based on vehicle load and speed, and converting residual energy into electric energy via the motor. When driving the hybrid electric vehicle, drive wheels of the vehicle are rotated by the electric motor that is powered by electricity. In this case, how to use electricity more efficiently may be very important.

Development and progress of the electric vehicle or the hybrid electric vehicle make it impossible to apply a conventional hydraulic brake system to the electric vehicle or the hybrid electric vehicle. Thus, there is a demand for a brake system that may perform braking using only an electric motor.

A system developed to fulfill the above-described demand is an electronically controlled brake booster. When a driver works a pedal, a rotor of a motor mounted in the electronically controlled brake booster rotates a ball screw to move a plunger forward, whereby the internal pressure of a cylinder is increased to enable transmission of braking pressure. In this case, a Proportional Integral (PI) controller is used to control the motor inside the electronically controlled brake booster. A general description of the PI controller will follow.

FIG. 1 is a view illustrating a general configuration of the PI controller.

In general, the PI controller is a representative control technique that is actually used the most in many application fields. As illustrated in FIG. 1, the PI controller basically takes the form of a feedback controller. The PI controller measures an output value y of an object to be controlled, compares the measured output value y with a reference value or set point r to calculate an error value e, and calculates a required control value using the error value e. That is, proportional-integral control is a parallel combination of integral control in which a control signal is generated via integration of the error signal e and proportional control in which a control signal is generated via multiplication of appropriate proportional constant gains.

The PI controller constructs a system by multiplying proportional constant and integral constant gains. In general, constant control response may be acquired by tuning a PI gain value under a constant load condition.

However, to acquire desired control response under variable load, gain scheduling depending on load variation may be necessary.

### SUMMARY

Therefore, it is an aspect of the present invention to provide an electronically controlled brake booster which performs gain scheduling depending on load variation, achieving enhanced control response.

Additional aspects of the invention will be set forth in part in the description which follows and, in part, will be obvious from the description, or may be learned by practice of the invention.

In accordance with an aspect of the present invention, an electronically controlled brake booster includes a brake pedal sensor to detect a stroke of a brake pedal, a motor to transmit power required to generate a braking pressure, a cylinder pressure sensor to detect an internal pressure of a cylinder generated via the motor, and an electronic control unit which controls driving of the motor and which includes a target pressure setting element to set a target pressure using the detected brake pedal stroke information and a proportional-integral controller to perform proportional-integral compensation of an error between the target pressure and the pressure of the cylinder, wherein the electronic control unit further includes a proportional-integral gain adjustor to adjust at least one of a proportional gain and an integral gain of the proportional-integral controller using the cylinder pressure information detected via the cylinder pressure sensor.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a view illustrating a general configuration of a PI controller;

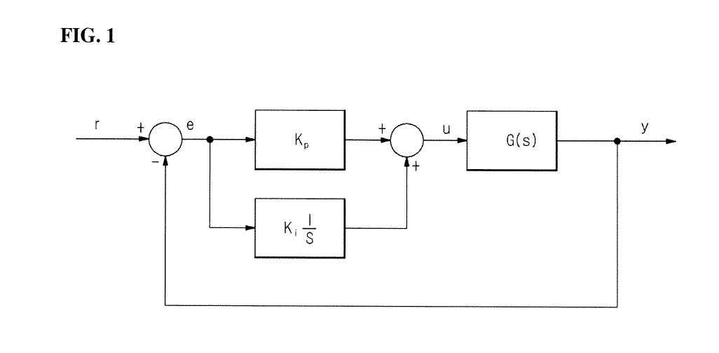

FIG. 2 is a view illustrating a configuration of an electronically controlled brake booster according to an embodiment of the present invention;

FIG. 3 is a control block diagram of the electronically controlled brake booster according to the embodiment of the present invention; and

FIG. 4 is a graph explaining pressure variation of a cylinder depending on variation of a pedal stroke.

### DETAILED DESCRIPTION

Reference will now be made in detail to the embodiments of the present invention, examples of which are illustrated in the accompanying drawings, wherein like reference numerals refer to like elements throughout.

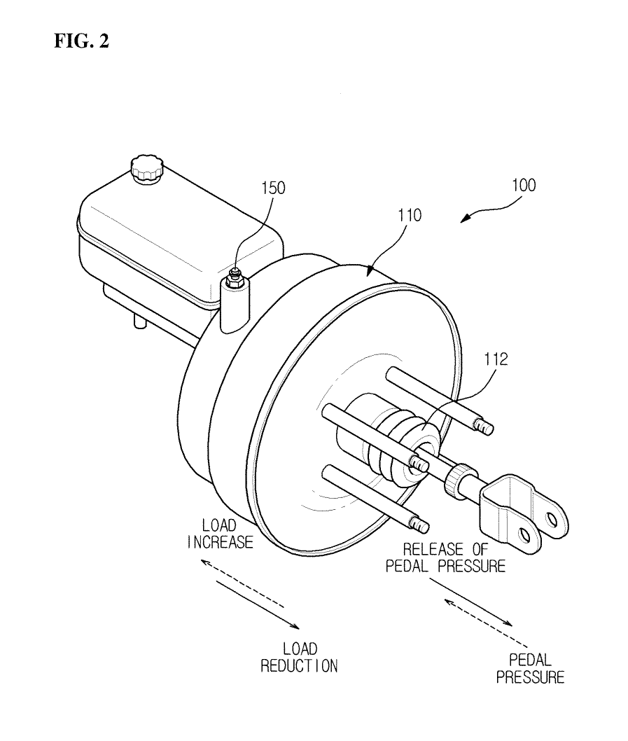

FIG. 2 is a view illustrating a configuration of an electronically controlled brake booster according to an embodiment of the present invention.

As illustrated in FIG. 2, the electronically controlled brake booster 100 according to the embodiment of the present invention includes a three-phase motor 110 to transmit power for generation of braking pressure, a ball screw 112 to perform rotation-translation conversion of force transmitted through the three-phase motor 110, and a cylinder pressure sensor 150 to detect the internal pressure of a cylinder.

As illustrated in FIG. 2, the electronically controlled brake booster 100 sets a target pressure based on an input pressure from a brake pedal (not shown), and causes forward movement of the three-phase motor 110 to reach the set target pressure. On the contrary, if pressure input from the brake pedal (not shown) is released, the electronically controlled brake booster 100 causes rearward-movement of the three-phase motor 110 to reduce the internal pressure of the cylinder.

That is, rotation of the three-phase motor 110 to increase the internal pressure of the cylinder is referred to as forward-movement of the three-phase motor 110. As illustrated in FIG. 2, forward-movement of the three-phase motor 110 increases the internal pressure of the cylinder, resulting in increased load.

On the other hand, when the three-phase motor 110 is rotated in reverse and a rotor of the three-phase motor 110 is moved rearward, load is gradually reduced. Then, if the rotor is moved rearward until further movement is no longer possible, a theoretical no-load state is realized.

If the three-phase motor 110 is operated based on a set PI gain corresponding to a full-load state, overshoot and undershoot repeatedly occur when the input pedal pressure is released, which results in system instability. In addition, the three-phase motor 110 may be movable rearward (toward a pedal) by approximately 2-3 mm by a rotating shaft of the electronically controlled brake booster 100. However, further movement causes generation of noise due to collision between the rotating shaft and the three-phase motor 110.

On the other hand, if the three-phase motor 110 is operated based on a set PI gain corresponding to a no-load state, a speed (time constant) to reach a normal state that creates a target pressure is considerably reduced, which makes it impossible for a driver to stop a vehicle when desired.

As such, gain scheduling depending on load variation may be necessary to acquire desired control response under variable load.

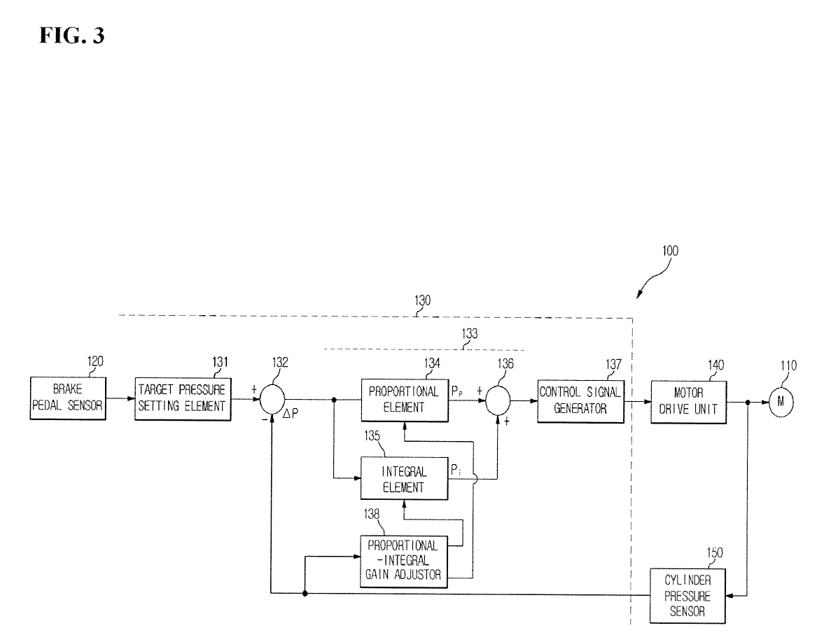

As illustrated in FIG. 3, the electronically controlled brake booster 100 according to the embodiment of the present invention includes the three-phase motor 110, a brake pedal sensor 120, an electronic control unit 130, a motor drive unit 140, and the cylinder pressure sensor 150.

The three-phase motor 110 transmits power to generate a braking pressure.

The brake pedal sensor 120 is mounted to a brake pedal (not shown). The brake pedal sensor 120 detects a stroke of the brake pedal, and transmits the detected brake pedal stroke information to the electronic control unit 130.

The electronic control unit 130 controls general operation of the electronically controlled brake booster 100. The electronic control unit 130 includes a target pressure setting element 131, an error calculator 132, a PI controller 133, a control signal generator 137, a PI-constant adjustor 138.

The target pressure setting element 131 sets a target pressure (a target brake pressure) using the brake pedal stroke information received from the brake pedal sensor 120, and outputs the set target pressure information to the error calculator 132.

The error calculator 132 calculates an error Δ P between the target pressure information received from the target pressure setting element 131 and cylinder pressure information received from the cylinder pressure sensor 150, and outputs the calculated error information Δ P to the PI controller 133.

The PI controller 133 includes a proportional element 134 to generate a proportional gain Kp for implementation of proportional control, an integral element 135 to generate an integral gain Ki for implementation of integral control, and an adder 136 to add an output signal of the proportional element 134 to an output signal of the integral element 135.

The proportional element 134 and the integral element 135 are connected to each other in parallel. The proportional element 134 outputs a proportional signal Pp, obtained by multiplying an error signal Δ P by a proportional gain Kp, to the adder 136. The integral element 135 outputs an integral signal Pi, obtained by integrating an error signal Δ I with an integral gain Ki, to the adder 136.

The proportional element 134 also multiplies a proportional coefficient output from the PI gain adjustor 138 by the proportional gain Kp. The integral element 135 also multiplies an integral coefficient output from the PI gain adjustor 138 by the integral gain Ki.

The adder 136 adds the proportional signal Pp to the integral signal Pi, and outputs a PI signal Ppi (Pp+Pi) to the control signal generator 137.

The control signal generator 137 generates a motor control signal using the PI signal Ppi received from the adder 136, and transmits the generated motor control signal to the motor drive unit 140.

The PI gain adjustor 138 includes a memory, such as ROM, etc. The PI gain adjustor 138 reads a proportional coefficient and an integral coefficient stored in the memory based on the cylinder pressure information received from the cylinder pressure sensor 150, and outputs the proportional coefficient to the proportional element 134 and the integral coefficient to the integral element 135.

The motor drive unit 140 controls driving of the three-phase motor 110 based on the motor control signal received from the control signal generator 137.

The cylinder pressure sensor 150 is mounted to the cylinder (not shown). The cylinder pressure sensor 150 detects the pressure of the cylinder, and feeds back the detected cylinder pressure information to the electronic control unit 130.

As described above, gain scheduling depending on load variation may be necessary to acquire desired control response in a load variable state.

Upon gain scheduling, to realize regenerative braking and other functions, the cylinder pressure sensor 150 is used to confirm a current pressure value of the cylinder caused by forward movement of the rotating shaft, i.e. current load acting on the rotating shaft. Additionally, improved control response may be accomplished by adjusting proportional and integral gains depending on load variation.

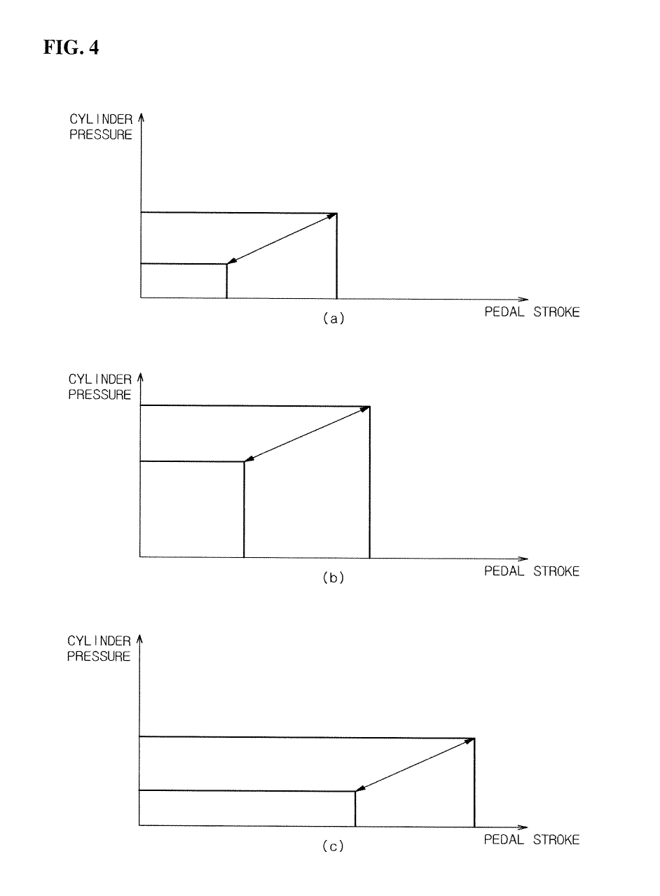

FIG. 4 is a graph explaining pressure variation of the cylinder depending on variation of a pedal stroke.

FIG. 4 shows that a required brake pressure continuously varies based on the current cylinder pressure and variation of the pedal stroke since the cylinder pressure situationally varies according to regenerative braking, Anti-lock Brake System (ABS) and Electronic Stability Control (ESC) operations of the electronically controlled brake booster 100.

FIG. 4(a) shows a normal case, and FIG. 4(b) shows that pressure variation of the cylinder occurs even if a pedal stroke value varies in the same manner as FIG. 4(a), and therefore it is necessary to set the proportional gain to a greater value.

In FIG. 4(c), the pressure of the cylinder is reduced despite a long driver pedal stroke, and therefore control operation to lower the proportional gain below an estimated value is performed to prevent generation of overshoot.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An electronically controlled brake booster comprising a brake pedal sensor to detect a stroke of a brake pedal, a motor to transmit power required to generate a braking pressure, a cylinder pressure sensor to detect an internal pressure of a cylinder generated via the motor, and an electronic control unit which controls driving of the motor and which includes a target pressure setting element to set a target pressure using the detected brake pedal stroke information and a proportional-integral controller to perform proportional-integral compensation of an error between the target pressure and the pressure of the cylinder,
wherein the electronic control unit further includes a proportional-integral gain adjustor to adjust at least one of a proportional gain and an integral gain of the proportional-integral controller using the cylinder pressure information detected via the cylinder pressure sensor.

2. The booster according to claim 1, wherein the cylinder pressure sensor is mounted to the cylinder and feeds back the detected cylinder pressure information to the electronic control unit.

3. The booster according to claim 1, wherein the proportional-integral controller includes:
a proportional element to generate the proportional gain for implementation of proportional control;
an integral element to generate the integral gain for implementation of integral control; and
an adder to add an output signal of the proportional element to an output signal of the integral element.

4. The booster according to claim 3, wherein the electronic control unit further includes a control signal generator to generate a motor control signal using a proportional-integral signal received from the adder.

5. The booster according to claim 4, further comprising a motor drive unit to control driving of the motor based on the motor control signal received from the electronic control unit.
